(19) United States
(12) Patent Application Publication
(10) Pub. No.: US 2012/0263558 A1
(43) Pub. Date: Oct. 18, 2012

(54) HUB CENTRIC WHEEL FASTENER

(76) Inventor: Richard C. Swanson, Orchard Park, NY (US)

(21) Appl. No.: 13/085,207

(22) Filed: Apr. 12, 2011

(51) Int. Cl. F16B 37/14; F16B 37/00

(52) U.S. Cl. 411/429; 411/432

(57) ABSTRACT

A wheel fastener comprises a nut including a central axis, an enlarged head, a cylindrical collar extending axially from the head, and an internal bore extending having internal threads, wherein the head includes an annular inner engagement surface that is a planar surface normal to the central axis. The wheel fastener further comprises a washer permanently mounted on the collar to be rotatable relative to the nut about the central axis but confined against axial movement along the collar. The washer includes an annular outer engagement surface arranged to face the inner engagement surface of the nut head for engagement therewith, wherein the outer engagement surface of the washer is a planar surface normal to the central axis. The length of the nut collar is adapted depending upon intended use in either a single-wheel or dual wheel assembly. Anti-theft embodiments include a torque-slipping cap around the head of the nut.

### FIELD OF THE INVENTION

The present invention relates generally to wheel fasteners for securing wheels on a vehicle such as a truck.

### BACKGROUND OF THE INVENTION

To secure a wheel on a vehicle, it is common to mount a central opening in the wheel axially onto a cylindrical wheel hub of the vehicle such that threaded studs spaced angularly about the hub axis extend through corresponding holes provided about the central opening of the wheel. In a hub centric mounting arrangement, the outer diameter of the hub corresponds to the inner diameter of the central opening in the wheel such that the hub itself acts to center the wheel on the hub axis. The wheel is then clamped against the wheel drum and hub flange by a tightening a threaded fastener onto each projecting stud.

Wheel fasteners comprising a nut and a washer coupled to the nut have been known since at least as early as the mid-1930s, as evidenced by U.S. Pat. No. 2,017,114 issued Oct. 15, 1935 and assigned to Motorwheel Corporation. This early patent describes a wheel fastener comprising a clamping nut that includes an enlarged hex head, a cylindrical collar extending axially from the head, and an internal bore extending axially through the head and the collar and having internal threads. The head has a frusto-conical inner engagement surface that tapers to meet the cylindrical collar at an oblique angle. The wheel fastener further comprises a washer mounted on the collar such that the washer is rotatable relative to the nut about the central axis but is confined against axial movement along the collar by a ring seated in an annular groove about the collar. The washer has a tapered surface corresponding to the taper angle of the inner engagement surface of the nut head. When the clamping nut is tightened onto a projecting stud, an inner annular surface of the washer is forced into engagement against an outer surface of the wheel disc.

U.S. Pat. No. 6,070,946 issued Jun. 6, 2000 to James Holmes discloses a wheel fastener substantially as taught in aforementioned U.S. Pat. No. 2,017,114, except that the cylindrical collar of the nut, also referred to as a skirt portion, is intentionally kept short in length such that it extends only into a stud-receiving hole of an outer wheel in a dual wheel truck assembly, and does not project into an aligned stud-receiving hole in an adjacent inner wheel of the assembly. Like U.S. Pat. No. 2,017,114 before it, the patent to Holmes discloses a frusto-conical inner engagement surface on the enlarged head of the nut that tapers to meet the cylindrical collar, and a washer having a correspondingly tapered surface.

Over the course of approximately thirty years in the truck wheel business, applicant has come to recognize that fasteners of the type described above are prone to failure, especially when the nut is over-tightened by too much applied torque, due to stress applied to the washer.

### SUMMARY OF THE INVENTION

The invention provides a more reliable wheel fastener by abandoning the tapered mating configuration between the nut and washer that has been used for over seventy-five years.

A wheel fastener of the present invention generally comprises a nut including a central axis, an enlarged head, a cylindrical collar extending axially from the head, and an internal bore extending axially through the head and the collar and having internal threads, wherein the head includes an annular inner engagement surface that is a planar surface normal to the central axis. In one embodiment, the annular inner engagement surface of the enlarged head is defined by a cylindrical shoulder for improved clamping force. The wheel fastener further comprises a washer permanently mounted on the collar such that the washer is rotatable relative to the nut about the central axis but is confined against axial movement along the collar, the washer including an annular outer engagement surface arranged to face the inner engagement surface of the nut head for engagement therewith, wherein the outer engagement surface of the washer is a planar surface normal to the central axis.

The enlarged head of the nut also includes an outer end surface axially spaced from the inner engagement surface, an external surface connecting the outer end surface to the inner engagement surface. In an anti-theft embodiment, the enlarged head further includes a radial shoulder between the inner engagement surface and the external surface, and the wheel fastener further comprises an anti-theft cap arranged about the enlarged head of the nut. The anti-theft cap includes an open outer end and a inner end having a lip projecting radially inward to engage the radial shoulder of the enlarged head of the nut, wherein the anti-theft cap is sized to rotate relative to the nut such that torque applied to the anti-theft cap is not transmitted to the enlarged head of the nut. A plurality of pin-receiving openings may be provided through the outer end surface of the nut head in a keyed configuration, thereby enabling torque to be applied to the nut head with the use of a special matching tool. The anti-theft cap is confined between the shoulder and the outer engagement surface of the washer against axially directed movement. As a result, it cannot be pulled off to expose the external surface of the nut head.

### BRIEF DESCRIPTION OF THE DRAWINGS

The nature and mode of operation of the present invention will now be more fully described in the following detailed description of the invention taken with the accompanying drawing figures, in which:

FIG. 1 is partially sectioned view of a hub centric wheel fastener for single wheel mounting in accordance with a first embodiment of the present invention;

FIG. 2 is an end view of the wheel fastener shown in FIG. 1;

FIG. 3 is a partially sectioned view illustrating the wheel fastener of FIG. 1 in a single wheel mounting arrangement;

FIG. 4 is an enlarged cross-sectional view of a washer forming part of the wheel fastener shown in FIG. 1;

FIG. 5 is partially sectioned view of a hub centric wheel fastener for dual wheel mounting in accordance with a second embodiment of the present invention;

FIG. 6 is an end view of the wheel fastener shown in FIG. 5;

FIG. 7 is a partially sectioned view illustrating the wheel fastener of FIG. 5 in a dual wheel mounting arrangement;

FIG. 8 is partially sectioned view of a hub centric wheel fastener with anti-theft lockout device for single wheel mounting in accordance with a third embodiment of the present invention;

FIG. 9 is an end view of the wheel fastener shown in FIG. 8;

FIG. 10 is a partially sectioned view illustrating the wheel fastener of FIG. 8 in a single wheel mounting arrangement;

FIG. 11 is partially sectioned view of a hub centric wheel fastener with anti-theft lockout device for dual wheel mounting in accordance with a fourth embodiment of the present invention;

FIG. 12 is an end view of the wheel fastener shown in FIG. 11; and

FIG. 13 is a partially sectioned view illustrating the wheel fastener of FIG. 11 in a dual wheel mounting arrangement.

### DETAILED DESCRIPTION OF THE INVENTION

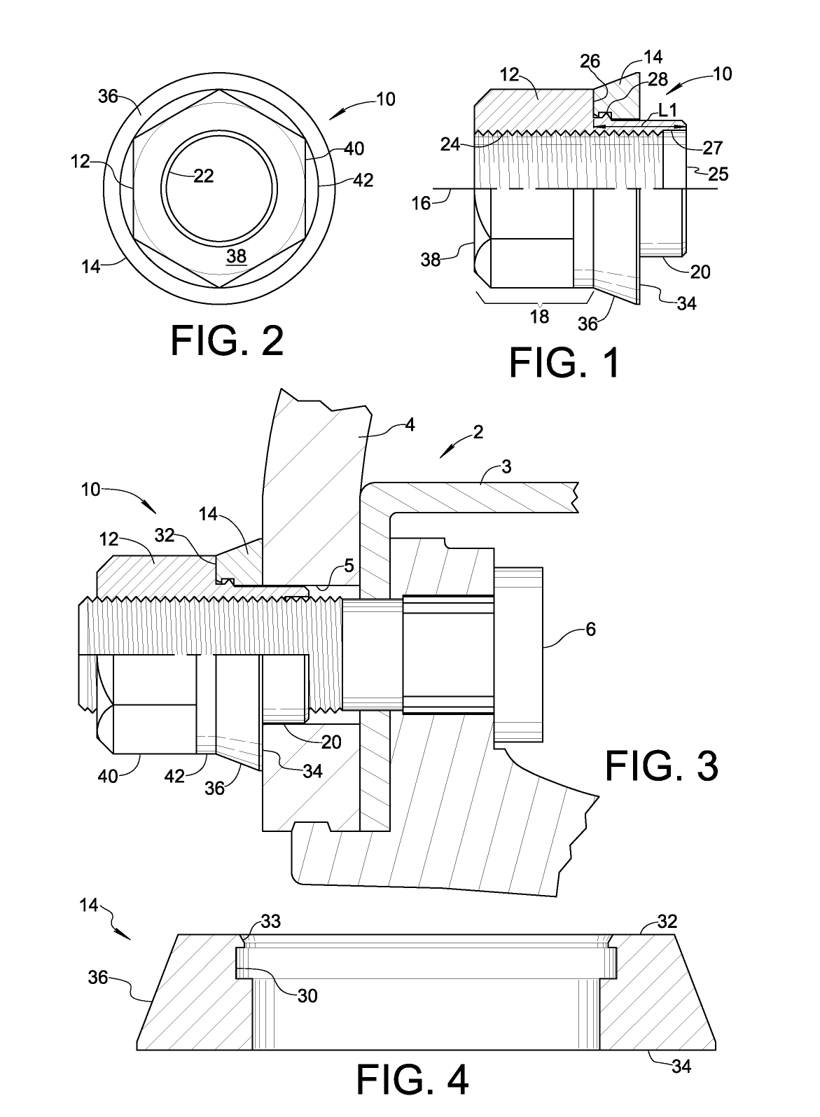

FIGS. 1-3 show a wheel fastener 10 formed in accordance with a first embodiment of the present invention. Wheel fastener 10 generally comprises a nut 12 and a washer 14. FIG. 4 is an enlarged view of washer 14 showing the washer in greater detail.

Nut 12 includes a central axis 16, an enlarged head 18, and a cylindrical collar 20 extending from head 18 along central axis 16. Nut 12 further includes a bore 22 extending axially through head 18 and collar 20. Bore 22 has internal threads 24 for mating with a wheel-mounting stud as will be described below with reference to FIG. 3. In an advantageous configuration, internal threads 24 are slightly recessed from a leading end 25 of collar 20 to provide a non-threaded entry portion 27 in the internal bore for facilitating engagement of fastener 10 onto a stud. Head 18 includes an annular inner engagement surface 26 which is a planar surface normal to central axis 16. Head 18 further includes an outer end surface 38 axially spaced from inner engagement surface 26, and an external surface 40 connecting outer end surface 38 to inner engagement surface 26. In the embodiment shown, a portion of external surface 40 has a hexagonal shape when viewed along axis 16 commonly known in the art for enabling torque to be applied with a torque wrench or similar tool. External surface 40 of nut head 18 also includes a cylindrical shoulder 42 arranged adjacent to washer 14 for defining annular inner engagement surface 26; this distributes the force of the nut over a greater area of the washer, thereby providing better clamping performance. Nut 12 may be machined from alloy steel, for example SAE Grade 1144, 8620, 4140, or 4150 alloy steel, or other suitable material; SAE Grade 1144 is currently preferred. The size of the hexagonal portion of head 18 is subject to design choice; by way of example, a 33 mm metric hexagonal head may be provided. The pitch of threads 24 is chosen for mating with a standard stud thread size; again by way of example, a 22-1.5 mm metric thread may be used.

Washer 14 is permanently mounted on collar 20 with slight clearance between an inner diameter of the washer and an outer diameter of the collar such that washer 14 is rotatable relative to nut 12 about central axis 16. Washer 14 is confined against axial movement along collar 20 by an annular lip 28 projecting radially outward from the outer diameter of cylindrical collar 20 and received within a ring-shaped groove 30 formed around the inner diameter of washer 14. Washer 14 includes an annular outer engagement surface 32 arranged to face the inner engagement surface 26 of the nut head 18 for surface-to-surface engagement therewith, wherein the outer engagement surface 32 is a planar surface normal to central axis 16. A beveled internal rim 33 extends between outer engagement surface 32 and internal groove 30. Washer 14 further includes an annular inner clamping surface 34 parallel to outer engagement surface 32. An external surface 36 of washer 14 connects outer engagement surface 32 with inner clamping surface 34. External surface may be tapered or radially stepped between outer engagement surface 32 and inner clamping surface 34 such that inner clamping surface 34 has a surface area greater than the surface area of outer engagement surface 32, whereby the clamping force of nut 12 is distributed over a greater area of the washer to provide a stronger fastener with better clamping performance. In the embodiment shown in FIGS. 1-3, external surface 36 has a conical taper providing a frusto-conical external surface from outer engagement surface 32 to an axial location near inner clamping surface 34. Washer 14 may be machined from alloy steel, for example SAE Grade 1144, 8620, 4140, or 4150 alloy steel, or other suitable material; SAE Grade 4140 is currently preferred.

In a currently preferred manufacturing method, lip 28 of nut 12 is machined for a slight interference fit with rim 33 of washer 14, nut 12 is chilled to a temperature in a range from 32° F.-38° F. to cause thermal contraction of the nut including lip 28, washer 14 is pressed onto collar 20 in an axial direction until groove 30 receives lip 28, and the mated parts 12, 14 are allowed to reach room temperature such that washer 14 cannot be pulled off of collar 20 but the washer can rotate about axis 16 relative to the collar. The assembled fastener 10 may then be heat treated and plated. Heat treating to a hardness of in the range 32-38 Rockwell C is currently preferred. Currently preferred plating finish is black oxide, phosphate or zinc-yellow chromate. The manufacturing method described herein, which avoids separately heat treating and plating the individual nut 12 and individual washer 14, essentially eliminates failures.

FIG. 3 shows fastener 10 installed in a single wheel assembly 2, wherein reference numeral 3 corresponds to a wheel drum, reference numeral 4 corresponds to a wheel disc having stud holes 5 (only one being visible in FIG. 3), and reference numeral 6 corresponds to a threaded stud. As may be seen, the length L1 of collar 20 is chosen to extend partially into stud hole 5 when fastener 10 is tightened onto stud 6.

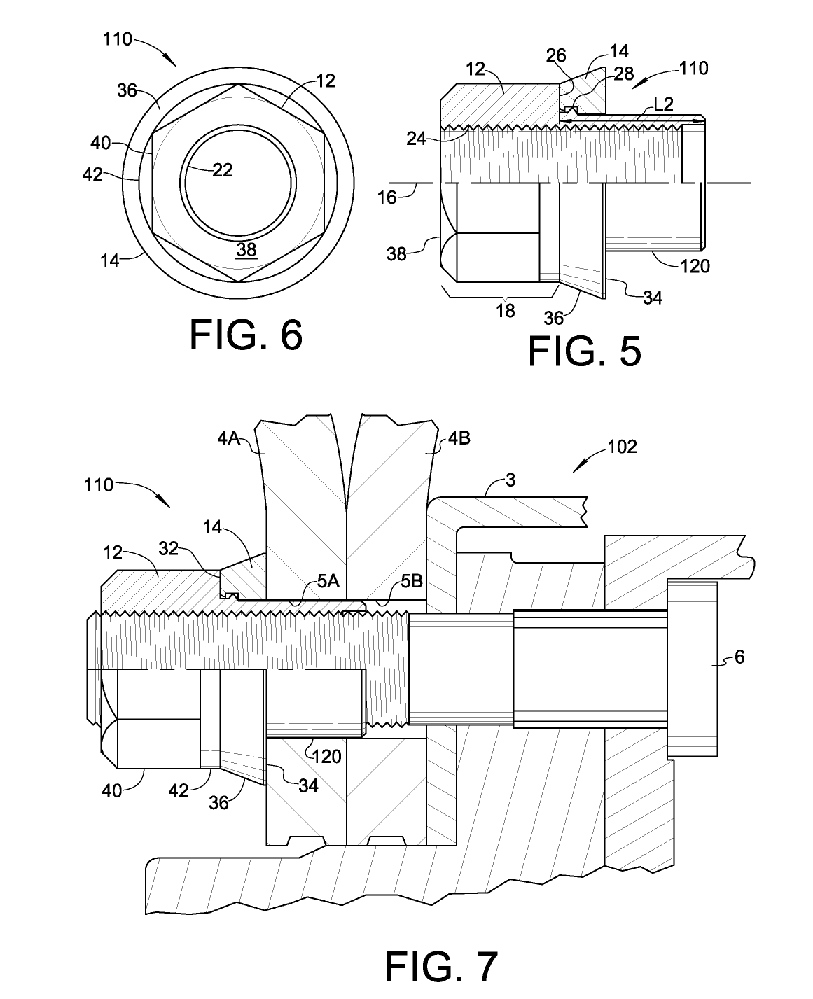

FIGS. 5-7 show a fastener 110 formed in accordance with a second embodiment of the present invention. Fastener 110 is similar to fastener 10 shown in FIGS. 1-3, except that fastener 110 is adapted for use in a dual wheel assembly 102 having an outer wheel disc 4A and an inner wheel disc 4B as shown in FIG. 7. Specifically, nut 12 of fastener 110 has a collar 120 that is significantly longer than collar 20 of the first embodiment. As seen in FIG. 7, the length L2 of collar 120 is greater than length L1 and is chosen such that collar 120 extends completely through stud hole 5A in outer wheel disc 4A and partially into aligned stud hole 5B in inner wheel disc 4B.

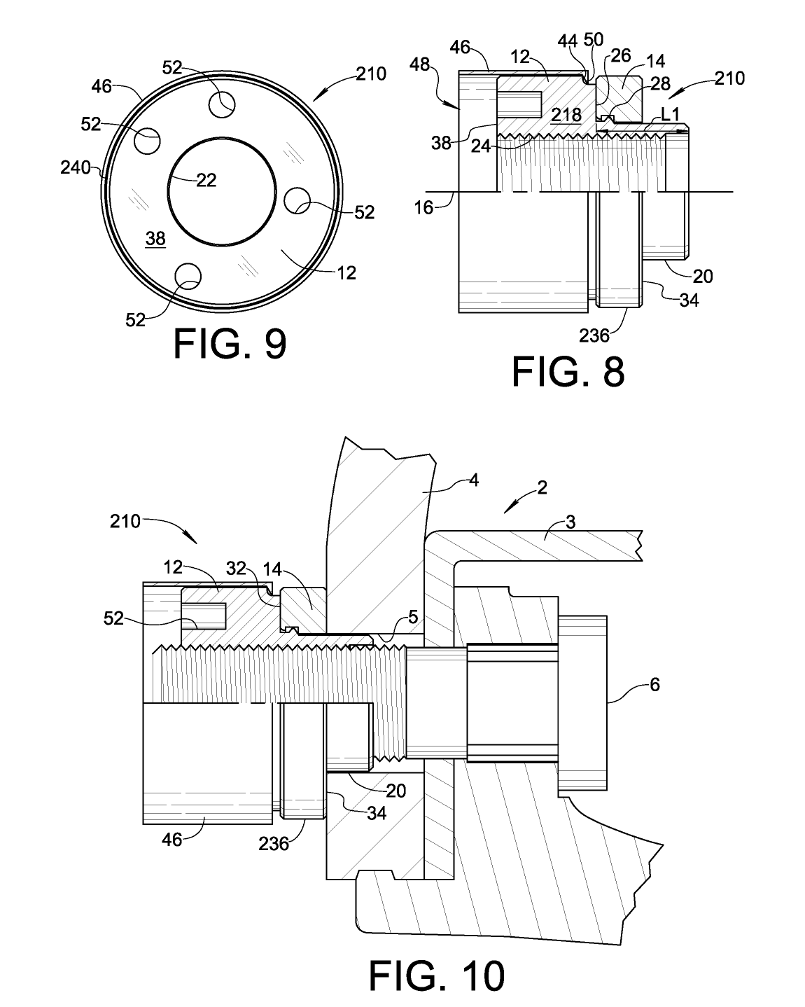

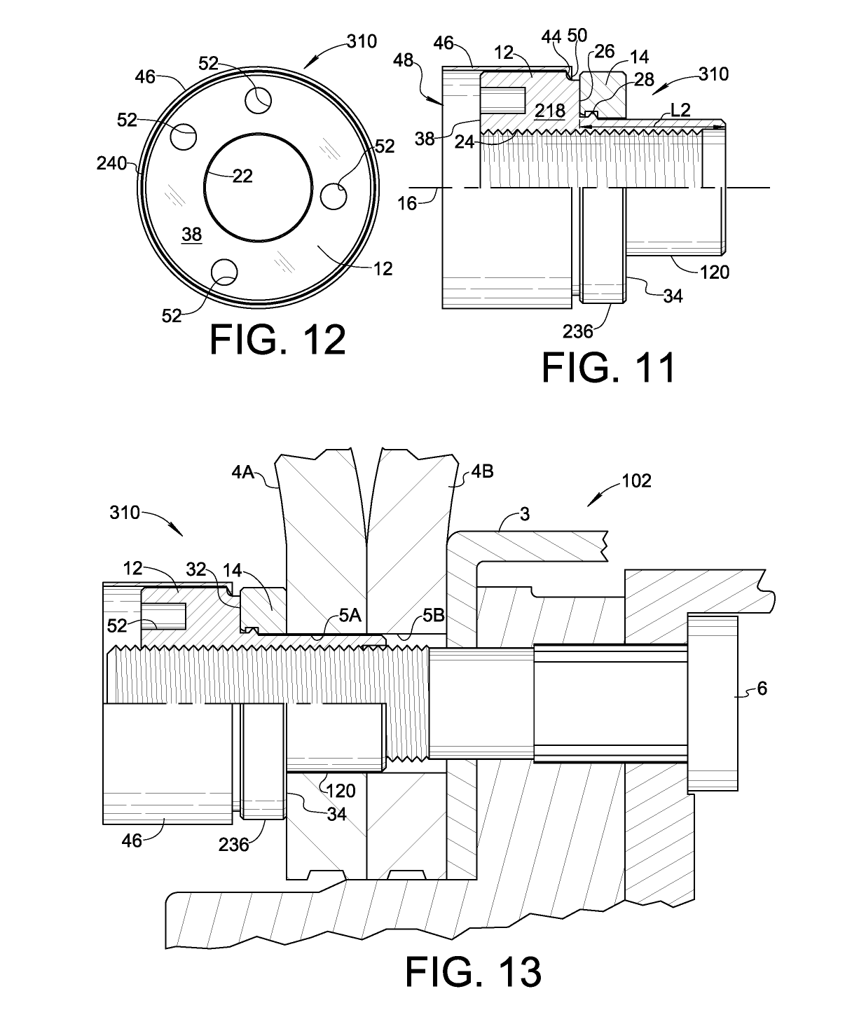

FIGS. 8-10 and 11-13 depict third and fourth embodiments of the present invention that each incorporate a lockout device into the fastener to prevent theft. The third embodiment shown in FIGS. 8-10 is designed for single wheel assemblies, whereas the fourth embodiment shown in FIGS. 11-13 is designed for dual wheel assemblies.

Wheel fastener 210 of the third embodiment is similar to wheel fastener 10 of the first embodiment, except modifications are made with respect to an enlarged head 218 of nut 12 to prevent theft, and washer 14 has a cylindrical external surface 236 instead of a frusto-conical external surface. An external surface 240 of enlarged head 218 is generally cylindrical and head 218 is formed to include a radial shoulder 44 between inner engagement surface 26 and the external surface 240. Head 218 lacks a hexagonal or other polygonal configuration for torque application. An anti-theft cap 46 is permanently arranged about enlarged head 218 of the nut and includes an open outer end 48 and an inner end having a lip 50 projecting radially inward to engage the radial shoulder 44 of enlarged head 218. Anti-theft cap 46 is sized to rotate relative to nut 12 such that torque applied to the anti-theft cap is not transmitted to enlarged head 218 of nut 12. Head 218 is adapted so that torque may only be applied to the head using a special customized tool. For example, a plurality of pin-receiving openings 52 may be provided through outer end surface 38 of head 218 in a unique pattern, and a special wrench adapter having pins located and sized to mate with the openings 52 may be supplied with fastener 210. In this regard, applicant's earlier U.S. Pat. No. 6,910,355 entitled “Fastener Lockout Device” is hereby incorporated by reference in its entirety for its teaching of an adapter identified by reference numeral 14 in such patent.

As best seen in FIG. 10, anti-theft cap 46 extends axially beyond outer end surface 38 of the enlarged head 218 of nut 12, preferably at least enough to surround a portion of stud 6 protruding beyond outer end surface 38 if such a protruding portion exists. Anti-theft cap 46 may be confined between shoulder 44 and the outer engagement surface 32 of washer 14 to limit axially directed movement of the anti-theft cap. During manufacture, the anti-theft cap 46 is slipped onto and along the nut collar before washer 14 is installed, and then washer 14 is installed on the nut as described above. Anti-theft cap may be formed of the same material as nut 12 and washer 14, and may be heat treated and plated together with the other assembled fastener elements.

FIGS. 11-13 show a fastener 310 formed in accordance with a fourth embodiment of the present invention. Fastener 310 is similar to fastener 210 shown in FIGS. 8-10, except that fastener 310 is adapted for use in a dual wheel assembly 102 having an outer wheel disc 4A and an inner wheel disc 4B as shown in FIG. 13. Specifically, nut 12 of fastener 310 has a collar 120 that is significantly longer than collar 20 of the third embodiment. As seen in FIG. 13, the length L2 of collar 120 is chosen such that collar 120 extends completely through stud hole 5A in outer wheel disc 4A and partially into aligned stud hole 5B in inner wheel disc 4B.

The wheel fasteners disclosed herein remedy the problem of failure and allow simplified manufacturing. The fastener embodiments of the present invention easily withstand 500 ft-lbs of applied torque, whereas the same applied torque is known to cause failures in prior art fasteners due to the wedge-like action of the nut with respect to the washer. The anti-theft embodiments provide an all-in-one anti-theft wheel fastener that is easy to use and avoids loss of parts.

While the invention has been described in connection with exemplary embodiments, the detailed description is not intended to limit the scope of the invention to the particular forms set forth. The invention is intended to cover such alternatives, modifications and equivalents of the described embodiment as may be included within the spirit and scope of the invention.

### LIST OF REFERENCE NUMERALS

2 Single wheel assembly

3 Wheel drum

4 Wheel disc of single wheel assembly

4A, 4B Inner and outer wheel discs of dual wheel assembly

5 Stud hole through wheel disc of single wheel assembly

5A, 5B Stud holes through inner and out wheel discs of dual wheel assembly

6 Stud

10 Wheel fastener of first embodiment

12 Nut

14 Washer

16 Central axis

18 Enlarged head of nut in first and second embodiments

20 Collar of nut in first and third embodiments

22 Bore through nut

24 Internal threads of nut

25 Leading end of collar

26 Inner engagement surface of nut head

27 Non-threaded entry portion of nut bore

28 Lip of collar

30 Internal groove of washer

32 Outer engagement surface of washer

33 Internal rim of washer

34 Inner clamping surface of washer

36 External surface of washer in first and second embodiments

38 Outer end surface of nut head

40 External surface of nut head in first and second embodiments

42 Cylindrical shoulder of nut head 18

44 Radial shoulder of nut head 218

46 Anti-theft cap

48 Open outer end of anti-theft cap

50 Lip of anti-theft cap

52 Pin-receiving openings in nut head 218

102 Dual wheel assembly

110 Wheel fastener of second embodiment

120 Collar of nut in second and fourth embodiments

210 Wheel fastener of third embodiment

218 Enlarged head of nut in third and fourth embodiments

236 External surface of washer in third and fourth embodiments

240 External surface of nut head in third and fourth embodiments

310 Wheel fastener of fourth embodiment

L1 Length of nut collar in first and third embodiments for single wheel assembly

L2 Length of nut collar in second and fourth embodiments for dual wheel assembly

What is claimed is:

1. A wheel fastener comprising:
a nut including a central axis, an enlarged head, a cylindrical collar extending axially from the head, and an internal bore extending axially through the head and the collar and having internal threads, wherein the head includes an annular inner engagement surface, wherein the inner engagement surface is a planar surface normal to the central axis;
a washer permanently mounted on the collar such that the washer is rotatable relative to the nut about the central axis but is confined against axial movement along the collar, the washer including an annular outer engagement surface arranged to face the inner engagement surface of the nut head for engagement therewith, wherein the outer engagement surface of the washer is a planar surface normal to the central axis.

2. The wheel fastener according to claim 1, wherein the washer includes an inner clamping surface greater in surface area than the outer engagement surface of the washer.

3. The wheel fastener according to claim 2, wherein the washer includes a frusto-conical external surface between the outer engagement surface and the inner clamping surface.

4. The wheel fastener according to claim 2, wherein the washer includes an annular groove about an internal circumference thereof, wherein the groove is located between and spaced from the outer engagement surface and the inner clamping surface of the washer, and the cylindrical collar of the nut includes an integral annular ridge about an external circumference thereof for receipt within the groove of the washer.

5. The wheel fastener according to claim 1, wherein the enlarged head of the nut includes a polygonal configuration.

6. The wheel fastener according to claim 1, wherein the internal threads are recessed from a leading end of the collar to provide a non-threaded entry portion in the internal bore.

7. The wheel fastener according to claim 1, wherein the enlarged head of the nut includes an outer end surface axially spaced from the inner engagement surface, an external surface connecting the outer end surface to the inner engagement surface, and a radial shoulder between the inner engagement surface and the external surface, and wherein the wheel fastener further comprises:
an anti-theft cap permanently arranged about the enlarged head of the nut, wherein the anti-theft cap includes an open outer end and a inner end having a lip projecting radially inward to engage the radial shoulder of the enlarged head of the nut, wherein the anti-theft cap is sized to rotate relative to the nut such that torque applied to the anti-theft cap is not transmitted to the enlarged head of the nut.

8. The wheel fastener according to claim 7, wherein the enlarged head of the nut includes a plurality of pin-receiving openings through the outer end surface.

9. The wheel fastener according to claim 7, wherein the anti-theft cap extends axially beyond the outer end surface of the enlarged head of the nut.

10. The wheel fastener according to claim 7, wherein the anti-theft cap is confined between the radial shoulder and the outer engagement surface of the washer against axially directed movement.
